(19) United States
(12) Patent Application Publication
(10) Pub. No.: US 2008/0196525 A1
(43) Pub. Date: Aug. 21, 2008

(54) Stop Device For a Spindle Drive

(75) Inventors: Jens Bohlen, Eyendorf (DE); Hans-Joachim Hurschler, Ellerbek (DE); Thomas Krueger, Buchholz (DE); Jan Maak, Seevetal (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/589,678

(22) PCT Filed: Dec. 15, 2004
(86) PCT No.: PCT/EP04/14268

§ 371 Date: Dec. 4, 2007

(30) Foreign Application Priority Data
Feb. 17, 2004 (DE) 10 2004 007 550.6

(51) Int. Cl. F16H 25/20

(52) U.S. Cl. 74/89.37

(57) ABSTRACT

A stop device is provided for a spindle drive which consists of a threaded spindle and a spindle nut with a stop. The stop device includes a limit stop and also a faceplate arranged between the stop of the spindle nut and the limit stop. The limit stop and the stop of the spindle nut are offset in relation to one another and are able to act upon the faceplate such that a bending moment can be applied to the faceplate when the threaded spindle and spindle nut of the spindle drive are in a limit stop position relative to one another.

This application is a National Phase of PCT/EP2004/014268, filed Dec. 15, 2004, which claims the priority of DE 10 2004 007 550.6, filed Feb. 17, 2004, the disclosures of which are expressly incorporated by reference herein.

### BACKGROUND AND SUMMARY OF THE INVENTION

The present invention relates to a stop device for a spindle drive, which consists of a threaded spindle and a spindle nut with a stop, the stop device comprising a limit stop.

In general, such spindle drives with corresponding stop devices are used in vehicle construction for adjusting individual elements relative to one another, where a threaded spindle or the like, which is driven remotely, runs in a spindle nut or the like. At the end of its thread, the threaded spindle here comes to a stop against the spindle nut in a limit stop position. However, this running up against the spindle nut takes place dynamically and leads to the possibility of the rotating threaded spindle becoming clamped with the spindle nut. When performing a backward adjustment, for example, it is not possible for the threaded spindle to be released from this clamped state in a noise-free manner. Release from the clamping position which has possibly arisen takes place jerkily and leads to significant noise being generated.

It is precisely when using the spindle drive just described, for example for the vertical and longitudinal adjustment of an electrical steering column in a vehicle, that it is thus possible for the threaded spindle and spindle nut to be clamped with one another as described above should they run up against one another into a limit position, and they generate considerable release noise when being released from the limit stop position. For reasons of comfort alone, however, this release noise is unwelcome in vehicle construction. The use of simple elastomeric dampers at the limit stop to prevent clamping and to prevent the noise which then occurs during release is not possible at the position described, since the forces occurring are too great and would damage corresponding elastomeric dampers.

DE 43 30 367 A1 discloses an adjustment device for the longitudinal adjustment of a seat in a motor vehicle, making use of a spindle drive comprising a threaded spindle and a spindle nut. A low-noise operation of the said adjustment device is ensured in this case by the arrangement of a spring element which acts in the direction of the spindle axis. This spring element is supported with prestress, on one hand, against a shoulder of the threaded spindle and, on the other hand, against a threaded shoulder of a bearing element that faces and is directly opposite this shoulder. This spring element is preferably formed by a prestressed spring assembly. Although this known adjustment device can produce a low-noise operation, it is structurally very complicated and also requires a high overall space requirement, particularly in the axial direction of the threaded spindle.

An object of the present invention is to provide a stop device for a spindle drive which overcomes the disadvantages of the prior art and, in particular, offers low-noise operation of the spindle drive combined with a simple structure and relatively small overall space requirement.

The object is achieved according to the invention by a stop device for a spindle drive comprising a stop device for a spindle drive, which consists of a threaded spindle and a spindle nut with a stop, comprising a limit stop, characterized in that the stop device further comprises a resiliently yielding faceplate which is arranged between the stop of the spindle nut and the limit stop, the limit stop and the stop of the spindle nut being offset in relation to one another and being able to act upon the faceplate such that a bending moment can be applied to the faceplate and the spring action of the faceplate produces a soft release from the stop position of the threaded spindle and spindle nut.

The stop device according to the invention for a spindle drive, which consists of a threaded spindle and a spindle nut with a stop, comprises a limit stop and also a faceplate which is arranged between the stop of the spindle nut and the limit stop. The limit stop and the stop of the spindle nut are offset in relation to one another and are able to act upon the faceplate so that a bending moment can be applied to the faceplate.

The use of a relatively simple faceplate according to the invention, this faceplate being arranged between the stop of the spindle nut and the limit stop, thus provides a structurally simple possibility whereby the faceplate and its spring action produce a soft release from the stop position of the threaded spindle and spindle nut and thus do not cause any noise to be generated. At the same time, the faceplate according to the invention requires only a small amount of space. The effectiveness of the stop device according to the invention results from the stop of the spindle nut and from the limit stop which are offset in relation to one another, the faceplate there being arranged therebetween. Consequently, a bending moment can be applied to the faceplate at least in one limit position.

In one currently preferred embodiment of the invention, the faceplate according to the invention is oriented perpendicularly to the axis defined by the shaft of the threaded spindle. In this way, and by contrast with the prior art, there is no need for a complicated prestressed damping element, and, preferably according to the invention, a faceplate thus positioned requires particularly little space. Nevertheless, good supporting and damping action is preferentially provided when the threaded spindle and spindle nut are in the limit stop position relative to one another.

In one particularly preferred embodiment of the stop device according to the invention, the stop of the spindle nut and the limit stop are arranged coaxially about the axis defined by the shaft of the threaded spindle. This requires only a very small amount of overall space.

The stop device according to the invention can also be configured such that the stop of the spindle nut has a first diameter and the limit stop has a second diameter, with the first diameter being larger than the second diameter. By virtue of the fact that the faceplate according to the invention can be supported against the corresponding stops of different diameter in the limit stop position, wedging of the threaded spindle and spindle nut relative to one another is also preferably avoided.

In a particularly compact and yet simple-to-implement embodiment of the stop device according to the invention, the faceplate is mounted on the limit stop.

The faceplate according to the invention can be made of an elastic material, preferably of metal, and most preferably of spring steel. The forces occurring can thus be handled in a particularly simple manner without any damage or breakage being caused to the faceplate provided according to the invention of the stop device according to the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a partial cross-sectional view showing a spindle drive in a first position with a stop device according to one currently preferred embodiment of the present invention;

FIG. 1b is a partial cross-sectional view of the spindle drive shown in FIG. 1a but in a second position; and

FIG. 2 is an enlarged view of the stop device according to the invention in the position shown in FIG. 1b.

### DETAILED DESCRIPTION OF THE DRAWINGS

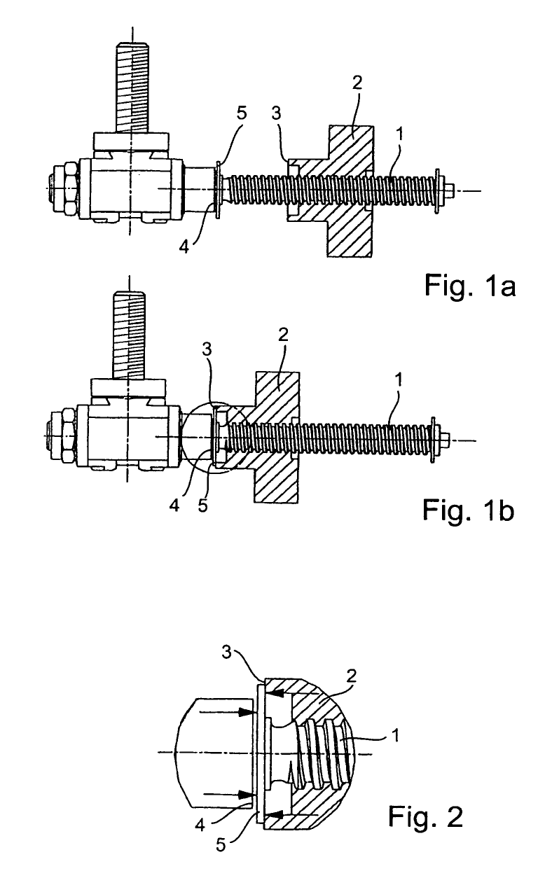

FIG. 1a shows a spindle drive which comprises a threaded spindle 1 and a spindle nut 2 with a stop 3. The stop device according to the invention comprises a limit stop 4 and also a faceplate 5 which is arranged between the stop 3 of the spindle nut 2 and the limit stop 4. The threaded spindle 1 and spindle nut 2 in the position shown in FIG. 1a are not in a limit stop position.

The limit stop position, or the position close to the limit stop position, of the threaded spindle 1 and spindle nut 2 is shown in the representation according to FIG. 1b.

The circular detail shown in FIG. 1b is represented on an enlarged scale in FIG. 2. The operation of the stop device according to the invention for a spindle drive will now be explained in more detail below with reference to FIG. 2.

The stop device according to the invention comprises—as already explained with reference to FIG. 1a—the limit stop 4 and the faceplate 5, with the faceplate 5 being arranged between the stop 3 of the spindle nut 2 and the limit stop 4. The limit stop 4 and the stop 3 of the spindle nut 2 are offset in relation to one another, and the stated stops can act upon the faceplate 5 such that a bending moment can be applied to the faceplate 5 in the limit stop position or in the position close to the limit stop position which is shown in FIG. 1b and in FIG. 2. The corresponding bending moment is illustrated in FIG. 2 by way of the opposing arrows.

According to the present invention, the faceplate 5 is preferably arranged perpendicularly to the axis defined by the threaded spindle 1. The stop 3 of the spindle nut 2 and the limit stop 4 are arranged coaxially about the axis defined by the shaft of the threaded spindle 1. As can be seen in FIG. 2, the stop 3 of the spindle nut 2 preferably has a first diameter which is larger than a second diameter of the limit stop 4. For reasons of higher stability and in order to take up particularly little overall space, the faceplate 5 can generally be mounted directly on the limit stop 4.

The faceplate 5 preferably consists of elastic material, particularly preferably of metal, and especially preferably of spring steel. This provides a particularly stable and yet simple-to-implement way of supporting the forces which occur when the spindle nut 2 and threaded spindle 1 of the spindle drive shown are in the limit stop position, without the possibility of any destruction or damage occurring to the faceplate 5.

The stop device according to the present invention for a spindle drive thus now makes it possible to achieve low-noise operation for this spindle drive while nevertheless combining a small overall space requirement with a relatively simple construction.

1-6. (canceled)

7. A stop device for a spindle drive having a threaded spindle and a spindle nut with a stop, comprising a limit stop and a resiliently yielding faceplate operatively arranged between the spindle nut stop and the limit stop, the limit stop and the spindle nut stop being offset relative to one another and actable upon the faceplate such that a bending moment is applicable to the faceplate and a spring action of the faceplate produces a soft release from the stop position of the threaded spindle and spindle nut.

8. The stop device as claimed in claim 7 wherein the faceplate is oriented perpendicularly to an axis defined by a shaft of the threaded spindle.

9. The stop device a claimed in claim 8, wherein the spindle nut stop and the limit stop are arranged coaxially about the threaded spindle shaft axis.

10. The stop device as claimed in claim 7, wherein the spindle nut stop has a first diameter, and the limit stop has a second diameter, with the first diameter being larger than the second diameter.

11. The stop device as claimed in claim 7, wherein the faceplate is operatively mounted on the limit stop.

12. The stop device as claimed in claim 7, wherein the faceplate is comprised of elastic material.

13. The stop device as claimed in claim 7, wherein the faceplate is comprised of metal.

14. The stop device as claimed in claim 13, wherein the faceplate is comprised of spring steel.
